(19) United States
(12) Patent Application Publication
(10) Pub. No.: US 2011/0025702 A1
(43) Pub. Date: Feb. 3, 2011

(54) Method of Constructing Images for an Imaging Appliance

(75) Inventor: Frédéric Lionti, Grenoble (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/845,610

(22) Filed: Jul. 28, 2010

(30) Foreign Application Priority Data
Jul. 31, 2009 (FR) FR 09 03798

(51) Int. Cl. G09G 5/02

(52) U.S. Cl. 345/589

(57) ABSTRACT

In an imaging appliance with display of the colour sequential type, a spatially monochrome image is displayed by preparing, for each complete image to be displayed, a sequence of monochrome images comprising an image for each colour of the light box, the monochrome images of the sequence being such that a pixel that is lit in one colour is off in the other colour(s), so that there is no colour break effect. Certain areas of the display can be reserved, in which the pixels are controlled in the usual way so as to use the entire colour palette of the display, for example to display a colour video image. The invention applies notably to the head-up imaging appliances applicable in onboard navigation systems, and to the imaging appliances for direct viewing.

### CROSS-REFERENCE TO RELATED APPLICATIONS

This application claims priority to foreign France patent application No. 0903798, filed on Jul. 31, 2009, the disclosure of which is hereby incorporated by reference in its entirety.

### FIELD OF THE INVENTION

The present invention relates to a method of constructing images for an imaging appliance, notably a head-up imaging appliance, but also direct viewing imaging appliances.

### BACKGROUND

Head-up imaging appliances, called HUD (Head-Up Display) appliances, or alternatively called “head-up collimator” or “head-up viewer”, developed for military aviation, are also used in civil avionics, and more recently in motor vehicles. Applications in the field of nautical navigation, where there is also the problem of the view of what is happening in the environment of the boat and of taking into account other information coming from onboard instruments.

In these applications, the aim is to project, into the field of view of the pilot, of the driver, information deriving from onboard instruments, that is thus overlaid on the external environment, by means of a combiner. A symbolic image is generated by an onboard computer with information supplied by the onboard instruments and projected, by a suitable optical system, onto the windscreen in the field of view of the pilot or of the driver. Concerning the avionics application, in daytime piloting, it is a symbolic image, typically representing the piloting information supplied by the instruments, such as altitude, trim, magnetic north, speed indicator, artificial horizon, trim, runway threshold, etc., according to a predetermined symbology. In night-time piloting, it is the superposition of a symbolic image and of a monochrome video image, received from an infrared camera and/or from a night sight and/or from a radar.

These HUD appliances normally use a monochrome imaging system, notably liquid crystal display LCD screens, to form the image which will then be projected by the HUD optical system.

Recently, there has been research into broadening the possibilities of these appliances, and more specifically into enriching the symbolic image supplied to the pilot. In particular, the onboard refined image processing systems, that are used to detect and identify obstacles, supply information that can be used advantageously. If we take the field of military avionics for example, it is advantageous to highlight the presence of a hazard, for example a transport aeroplane, or of a target, for example a fighter aeroplane, that might have been detected in the environment of the aeroplane. The aim may also be to display alert signals, originating from the flight management computer, following, for example, the detection of a failure.

The aim is not only to add extra symbol(s), representative of the information conveyed by these alert or alarm signals, to the projected symbolic image. The aim is to more specifically attract the attention of the pilot. The use of a coloured symbology, using a first colour, typically green, for the standard instrument symbology or the video images reconstructed from the infrared sensors, and at least one other colour, for example red, for additional alert information, is thus particularly advantageous. This applies to the other fields of application of these head-up imaging appliances.

This assumes the use of a colour imaging system, and not a monochrome imaging system.

The use of an imaging system with colour sequential addressing, notably an LCD screen with sequential colours (“colour sequential”), makes it possible to obtain these additional functional capabilities without losing in transmission, which is very important given the consumption constraints associated with all these onboard appliances.

It will be recalled that, in an imaging system with so-called colour sequential addressing, each time the image is refreshed, the imaging system is sequentially lit in different colours, at least two, by a light box controlled accordingly, the image refresh frame consisting of a number of subframes, one subframe for each colour. In the time of each subframe, the light box is driven to light the screen in the corresponding colour and all the pixels of the screen are addressed to display the corresponding video information. Generally, the imaging system is of the transmissive type, which makes it possible to obtain the best light power at the output.

The benefit of the colour sequential technique lies in the fact that a monochrome imaging system is retained, the colour being obtained by the colour sequential lighting of the light box. If we take the example of LCD transmissive screens, the monochrome screens have a white transmission coefficient of around 15 to 20%, much better than that of the same screens equipped with coloured filters, for which the transmission is at best only 7 to 8%. The gain in transmission is essential for the application concerned, because of the significant consumption constraints. An imaging system with a good transmission coefficient requires less power to be supplied to the light box to obtain the luminance level sought on the combiner of the HUD appliance to project the image formed on the imaging system onto the landscape background.

However, imaging systems with colour sequential addressing have a well known defect, called “colour break-up”. This defect originates from the fact that, in this addressing mode, the colours are spatially correlated: the eye is then capable of separating them in time. Briefly, to illustrate this problem, we will take the example of a colour sequential system with the three primary colours, red, green, blue. To display a white image, a red flash (during the “red” subframe), a green flash (during the “green” subframe) and then a blue flash (during the “blue” subframe) are superposed spatially, that is to say on each pixel of the imaging system, in succession.

The superposition of the three colours in the same place but at very short different times gives the eye the white rendering. The eye integrates time-wise and thus averages the superposition of the three primary colours.

If the eye of the observer does not move, the image is stable. However, if the eye of the observer moves (lateral movement or activation of the lateral viewing modes), the eye will perceive the time difference (stroboscopic effect of the colour breaks) between the three colours and will then perceive the three separate colours instead of the desired white. This colour break-up effect exists whenever at least two colours are superposed. It is an extreme nuisance, notably in the context of HUD imaging.

### SUMMARY OF THE INVENTION

The object of the invention is to resolve this technical problem in an HUD imaging appliance.

The technical solution provided consists in spatially separating the colours in the image to be displayed on the imaging system, that is to say in spatially separating the colour used for the background HUD symbology image and/or the video image reconstructed from the infrared cameras or other sensors, from the colour reserved for the display of additional information.

This spatial separation is reflected in a processing of the image to be displayed, such that the pixels used to display additional information in a reserved colour are all off in the application's background image display colour.

The solution provided to this technical problem can be applied more generally, including to imaging devices for direct viewing, using a colour sequential display, such as screens for laptop computers, PDAs, televisions, etc.

Notably, the image construction method according to the invention makes it possible to have a spatially monochrome image on the display, except in one or more areas of the display in which information is displayed in “full colour”: that is to say that, in these areas, the colour break-up defect is accepted.

The invention therefore relates to a method of constructing images for an imaging system with liquid crystal display of the colour sequential type and a light box capable of lighting said display sequentially in at least two colours. The method consists, for each display sequence of a complete image, in generating a sequence of images comprising an image for each colour of said light box, such that, at least for one set of pixels of the display, all the pixels of this set that are on in the image associated with one colour are off in each of the other images associated with the other colours of the sequence.

According to one aspect of the invention, said set of pixels encompasses all the pixels of the display: the displayed image is thus entirely spatially monochrome.

According to another aspect of the invention, other pixels of the display are reserved for a colour display using the entire colour palette of the display: the image displayed is then overall spatially monochrome, apart from one or more areas. In this or these area(s), colour break-up is accepted, in order to display, for example, a colour video signal, for example deriving from a camera in the visible spectrum.

The invention also relates to an imaging appliance comprising an imaging system comprising a liquid crystal display of the colour sequential type and a light box with at least two colours, in which said imaging system receives sequences of images to be displayed, generated according to an image construction method according to the invention, in order to display spatially monochrome images.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention.

Accordingly, the drawings and description thereof are to be regarded as illustrative in nature, and not as restrictive.

### BRIEF DESCRIPTION OF THE DRAWINGS

FIG. 1 diagrammatically illustrates a head-up imaging appliance;

FIG. 2 represents a sequential addressing sequence in three colours;

FIGS. 3a to 3c diagrammatically illustrate the images displayed in succession in each colour, according to the principle of the invention;

FIG. 4 illustrates the corresponding complete image perceived by the eye, spatially monochrome according to the inventive method;

FIG. 5 is a diagrammatic example of the image perceived by a pilot through his piloting windscreen, in daytime viewing, with an imaging appliance according to the invention;

FIG. 6 is an example of the image perceived by the pilot through his piloting windscreen, in night viewing, with an imaging appliance according to the invention.

### DETAILED DESCRIPTION

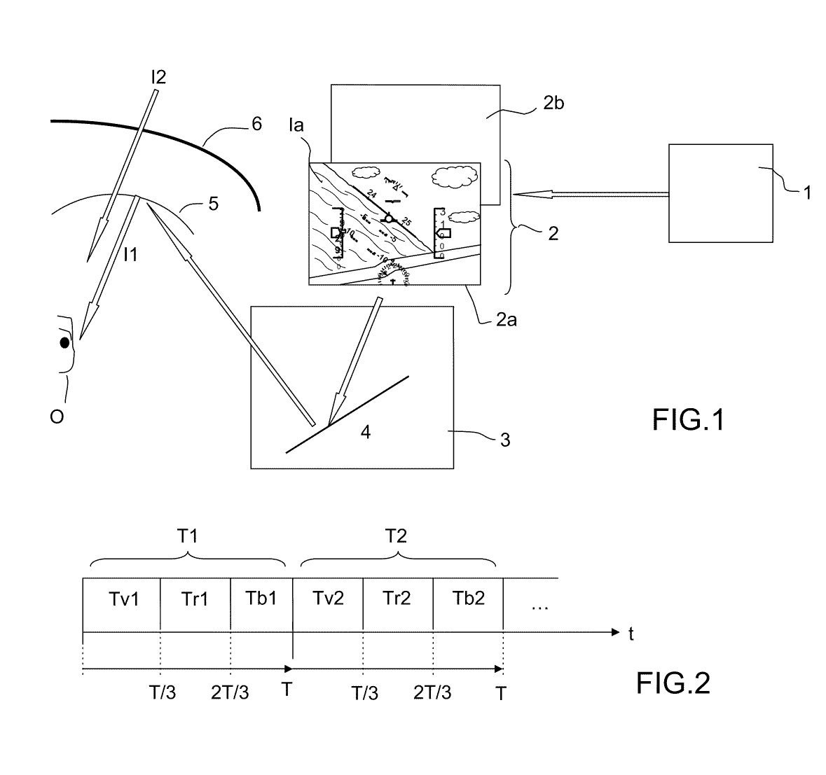

FIG. 1 diagrammatically illustrates a head-up imaging appliance, more specifically from the avionics field. It comprises a computer 1 which supplies a video signal to be displayed to an imaging system 2, comprising a transmissive screen 2a and a light box 2b.

A corresponding image Ia is displayed on the screen 2a. This image is refreshed at the screen frame frequency, typically 50 Hz (i.e. every 20 ms).

This image is transmitted to an optical system 3, on a semi-reflecting mirror 4, which returns the image to a combiner 5.

An observer O then sees an image I1 which is overlaid on the environment (landscape) I2, that he sees through the windscreen 6. If we assume the avionics context, the image I1 is an image collimated to infinity. If we assume the motor vehicle context, the image I1 is an image collimated to a few metres in front of the vehicle.

In the invention, the display 2a is a transmissive display, for example a transmissive LCD display, and of the colour sequential type. The term “transmissive” means that it is back-lit by the light box 2b, and the displayed image Ia is seen from the front. The expression “colour sequential” means that the display does not incorporate a coloured filter matrix: it is monochrome, and the colour is supplied by the light box, and the video signal comprises coloured frames for each display frame of an image: each coloured frame has a corresponding lighting colour from the light box. Thus, with each frame, the light box is ordered in sequence to display one colour, then another, each time for the time of the associated coloured frame. The light box is typically made up of groups of LEDs, each group of LEDs being characterized by a wavelength and the number of LEDs in each group being determined in order to have the required light power. Conventionally, the light box can light in each of the three primary colours: green, red and blue. However, it is possible to use only two colours, typically two primary colours such as green and red. It is also possible to have a light box capable of offering more individual colours, for example six colours, by using the primary colours and primary colour combinations. For example, it is possible to have a light box able to light successively, in any order, in red, green, blue, magenta (red plus blue), cyan (green plus blue) and yellow (red plus green). It is also possible to have white (red+green+blue). Light boxes of this type are well known to those skilled in the art. They generally comprise sets of red, green and blue LEDs, appropriately controlled in the sequence to light the display in the required individual colour.

FIG. 2 diagrammatically illustrates the composition of the image display frames on an imaging system 2 of the colour sequential type, for a light box with three individual colours, typically the three primary colours: red, green and blue. The figure shows two successive frames T1 and T2 displaying a complete image, typically at the 50 Hz frequency. Each display frame of a complete image comprises one frame for each colour, in the example three frames Tv1, Tr1, Tb1, respectively for the green, red and blue colours for the complete frame T1, and the three frames Tv2, Tr2, Tb2 for the same sequence of green, red and blue colours, for the complete frame T2.

When the addressing circuit of the LCD display processes the green frame, it orders each of the pixels of the screen to display the green frame information, and the light box is ordered to light in green. Then, it does the same for the red frame, then the blue frame, in sequence.

In this usual control mode, there are thus three images that are overlaid in each frame time T, that is to say, three colours that are overlaid in each pixel of the screen: as explained previously, the colours are thus spatially correlated.

In the invention, to prevent the colour break-up effect due to this spatial correlation, the coloured images to be displayed are generated so that a pixel that is on in one colour must necessarily be off in the other colours.

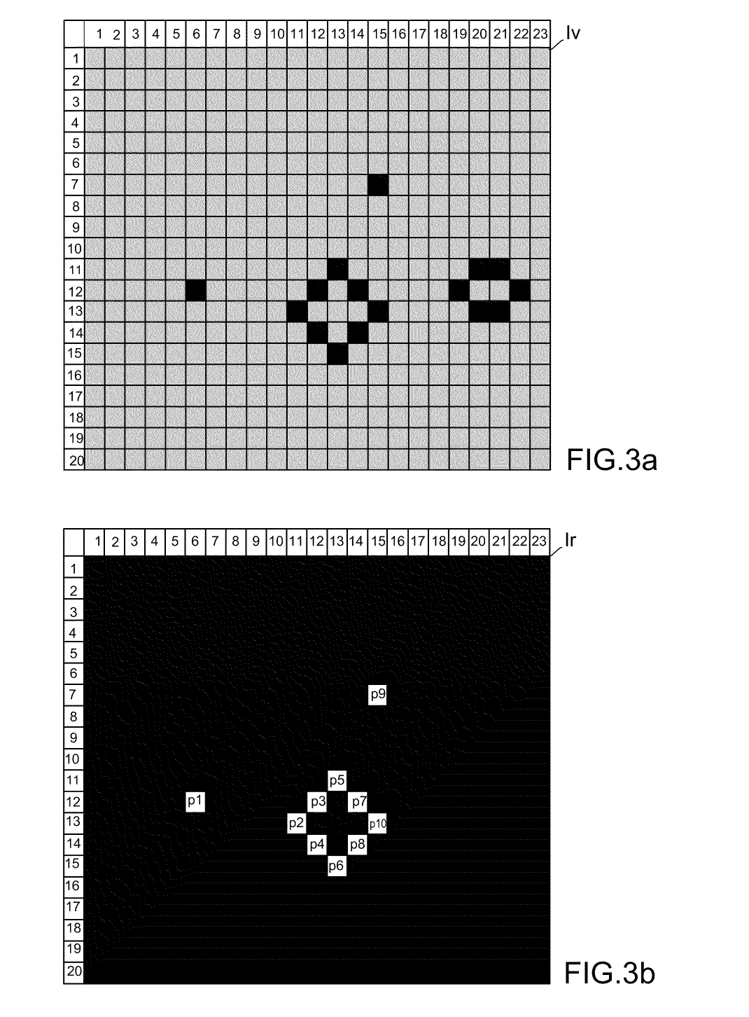

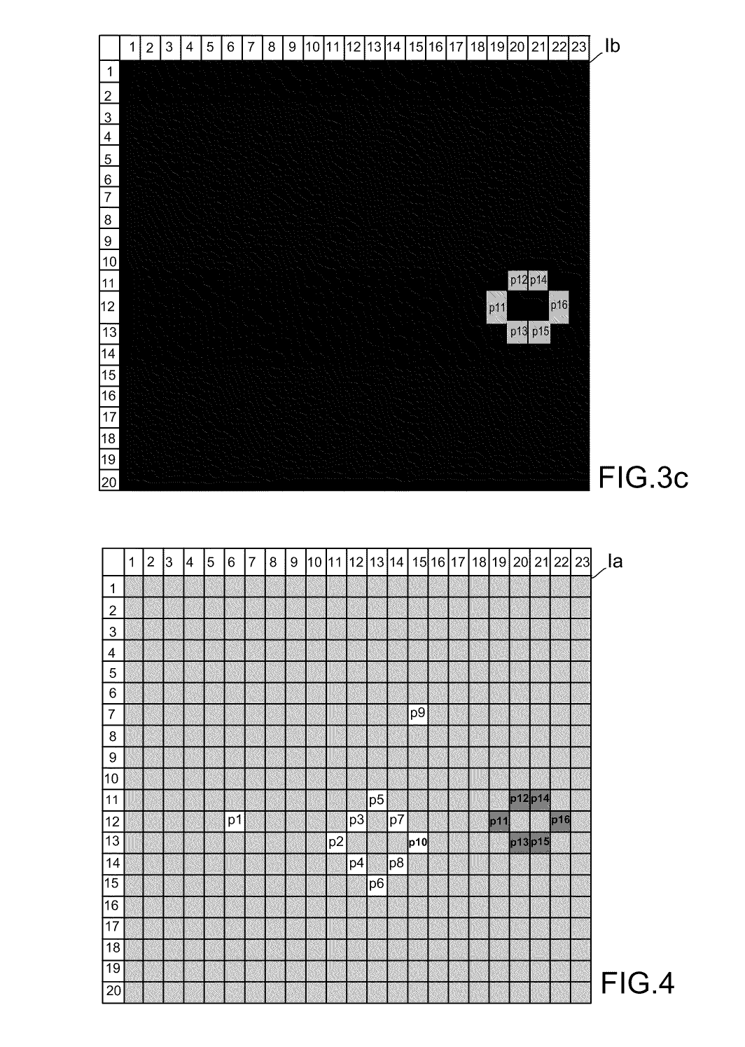

FIGS. 3a to 3c illustrate the construction according to the invention of an image to be displayed for a frame time T, and FIG. 4 shows the displayed image obtained. The image illustrated is simplified, with a single grey level in each colour (all the pixels in one colour display the same information), whereas typically, according to the displays being considered, it is possible to have, for example 16, 32, or even 256 grey levels for each colour.

The pixels that are off in one colour are black: they do not let any light pass. The other pixels let light pass. They are on. Depending on their position in the image, they are on in green, red or blue. In the example of FIGS. 3a to 3c and 4, the following representation of the colours has been chosen by convention: green, in a light grey, red in a very light grey and blue in a dark grey.

It will be recalled that a display is a pixel matrix structure: information is placed on each pixel that will give the grey level that is to be displayed at this point.

Thus, stating that a colour image is constructed from three images, one for each colour, such that a pixel that will be on in one colour will be off in the others, means that, in the other images, the dot will not allow light to pass: this will be a black dot.

The complete image displayed corresponding to the sequence of the three monochrome images, green, red and blue, constructed according to the invention, is illustrated in FIG. 4, on a display which, in the example, comprises 460 pixels distributed matrix-wise in 23 columns numbered 1 to 23 starting from the left of the image and 20 rows numbered from 1 to 20 starting from the top of the image, as indicated in the figure. Each pixel is identified by a row coordinate and a column coordinate.

The image Ia of FIG. 4 is constructed from three coloured images that are overlaid, the green image Iv of FIG. 3a, the red image Ir of FIG. 3b and the blue image Ib of FIG. 3c. These images are constructed by the computer 1, such that a pixel that is on in one of the coloured images will necessarily be off in the other two. These images are deliberately simple, to clearly illustrate the invention: in one colour, the grey level displayed is the same for all the pixels that are on in that colour. However, in practice, it is possible to display all the grey levels available in each colour.

FIG. 3a illustrates the colour image Iv to be displayed for the green colour. In an avionics application, this image typically corresponds to the HUD symbolic image comprising information from the onboard instruments, or even a monochrome video image reconstructed from signals from a sensor, for example an infrared camera, in night vision mode.

The black pixels in this colour image Iv are those that are deliberately off in the green colour, according to the principle of the invention, because they are reserved for information to be displayed in another colour of the light box, typically, in an avionics application, alarm signals or other information supplied by the onboard computer, and not only information from the navigation instruments, which is HUD “typical” information.

In the example, there are 16 pixels off, which correspond to the 16 pixels p1 to p16 which are on in a colour other than green in FIG. 4, and which are the pixels of the following column, row coordinates: p1(6,12); p2(11,13); p3(12,12); p4(12,14); p5(13,11); p6(13,15); p7(14,12); p8(14,14); p9(15;11); p10(15,13); p11(19,11); p12(20;11); p13(20,13); p14(21;11); p15(21,13); p16(22,12).

FIG. 3b illustrates the colour image Ir to be displayed in the red colour: these are, for example, alarm signals, generated by the onboard computer. These signals are displayed by using all or some of the reserved pixels, which are therefore off in the preceding green colour, and off in the blue colour. In the example, these are the 10 pixels p1 to p10. All the other pixels of the red image are off, corresponding to all the pixels reserved for green and those reserved for blue.

FIG. 3c illustrates the colour image Ib to be displayed in the blue colour: for example, objects that are detected in motion in the field of trajectory of the aeroplane by the onboard computer. These signals are displayed using all or some of the reserved pixels, which are therefore off in the green colour and off in the red colour. In the example, these are the following 6 pixels: p11 to p16. All the other pixels of the blue image are off, corresponding to all the pixels reserved for green and those reserved for red.

These three colour images Iv, Ir, Ib are displayed one after the other on the display in the time of a display frame, typically 20 milliseconds at 50 Hz, the light box being controlled accordingly to emit a green flash, then a red flash then a blue flash corresponding to the coloured frames, according to the sequencing indicated in FIG. 2. The eye of the observer integrates in time, and averages, the three images Iv, Ir, Ib and obtains the image Ia represented in FIG. 4.

In this image, there is no spatial correlation of the colours: the colour break-up effect does not exist.

In practice, it is possible to have, in each colour, the entire palette of grey levels, from the black level, off, to the strongest level, white. Thus, it should be noted that it is possible to have more black dots in an image than there are black dots reserved for the other colour or colours. However, in a given coloured image, there are necessarily at least as many black dots as there are dots reserved for the other individual colours of the light box.

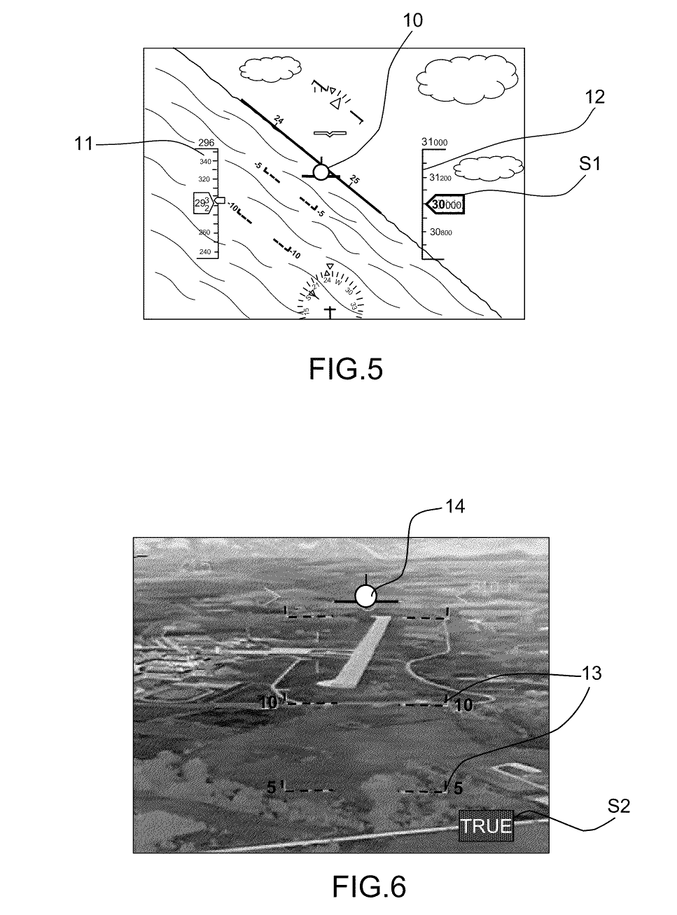

FIGS. 5 and 6 are practical illustrations of the image seen by a pilot, with a method of constructing images for a head-up imaging appliance according to the invention.

FIG. 5 corresponds to an observation in daytime piloting mode: the complete image comprises an HUD-typical symbolic image, with symbols that appear in black in the figure but which, in reality, are in green, and which gives, on a landscape background seen through the semi-transparent screen, the well known “HUD” information such as the trim 10 of the aeroplane, in the form of cursors, on the left, the pitch indicator 11, and on the right, the roll indicator 12. It will be noted that the symbology varies generally from one appliance to another. These symbology aspects, which are beyond the scope of the invention, and which are also well known in the avionics field, will not be detailed. Added to this symbolic image, according to the invention, is an alert signal S1, in the example the number 30.000 (the roll angle in the example) in a box. This signal S1 appears in bold black lines in the figure, but in reality it appears in a colour other than the HUD green symbolic image, for example in red. In this example, this signal S1 indicates a risk associated with too great a roll angle representing a risk of stalling of the aeroplane. The display sequence of the complete image as shown in FIG. 5 comprises the display, in synchronism with the sequenced lighting control of the light box, of at least one green image, corresponding to the HUD symbolic image and a red image, corresponding to the alert signal S1. If the sequence includes a blue image, all the pixels of this image are off.

FIG. 6 corresponds to an observation in night-time piloting mode: there is a complete image comprising an HUD image (simplified), which is the overlay of a monochrome video image in green levels, reconstructed, for example, from the monochrome signal from an infrared sensor, and a symbolic image, which appears in white in the figure, but which in reality is in green, which, in the example, represents the conformity of the landscape 13, and the nose of the aeroplane 14. Added to this image is a signal S2 according to the invention, represented by a dotted line square with the indication “TRUE” in bold black lines, but which, in reality, would appear, for example, in one of the other individual colours (other than green), for example in blue, or in cyan. This signal is, for example, used to indicate to the pilot that the new trim has indeed been taken into account by the onboard computer. Typically, this signal can be displayed in blinking form.

The invention that has just been described can be used to enrich an image with information supplied by the onboard computer. There are in fact embedded computers, in aeroplanes, motor vehicles or other navigation craft, that incorporate increasingly sophisticated information detection and processing functions, in conjunction with the indications supplied by the various onboard instruments, sensors or similar. The invention enables the pilot to easily analyse this additional information, by displaying it in a clearly visible and non-interfering form.

It is simple to implement: it is the computer that manages all the information to generate the sequence of monochrome images according to the image construction method described. Depending on whether there is or is not information to be displayed in one or more colours other than the typical, background colour, it manages the extinguishing of the pixels in the background images, and in the other colours, according to the number of colours to be managed. The management of the colours according to the information to be displayed may typically be performed according to an association table.

It applies notably to all the onboard navigation systems, for example, but not exclusively, in the avionics, motor vehicle and nautical fields. It is not limited to a given number of colours, in particular it is not limited to the display of two or three individual colours. Light boxes are known which allow a control mode in which it is possible to form light beams in secondary colours, from the primary colours, typically, yellow (red plus green), cyan (blue plus green), magenta (blue plus red). According to the invention, a complete image can be formed by a sequence of six monochrome images, in conjunction with a lighting sequence in the six colours: red, green, blue, magenta, cyan, yellow, or even seven images if white were added (red plus green plus blue).

The invention can also be used to display on the screen a spatially monochrome image, apart from an area or areas in which colour images will be displayed, using the display's colour palette. For example, with a display with 256 grey levels for each individual colour, it is possible to use, in these areas, potentially all the colours in the palette of 16.7 million colours available.

This makes it possible, for example, to display in a corner of the display screen, a colour video image: in this area, the colour break-up phenomenon is then accepted. The colour video image may be, for example, an image reconstructed from the video signal from a camera operating in the visible range.

The construction method according to the invention is then the same, except that, for the pixels of this area or of these areas, the pixels are controlled in the usual way, with a grey level in each individual colour, to ultimately obtain the desired colour.

The invention can further be extended to imaging appliances that use a colour sequential LCD display for direct vision.

The invention is not limited to the examples illustrated and to the fields of application cited by way of example. It applies in all fields in which there is a need to add or embed additional information in a colour other than a monochrome background image, whether in the form of a symbolic image or a video image.

1. A method of constructing images in order to display a complete image on an imaging system comprising a liquid crystal display of the colour sequential type and a light box capable of lighting said display sequentially in at least two colours, wherein the method comprises, for each display sequence of a complete image, in generating a sequence of images comprising an image for each colour of said light box, such that, at least for one set of pixels of the display, all the pixels of this set that are on in the image associated with one colour are off in each of the other images associated with the other colours of the sequence.

2. The method according to claim 1, in which a first colour is used to display a monochrome background image comprising a symbolic image, representing information supplied by navigation instruments.

3. The method according to claim 2, in which said background image also comprises a monochrome video image.

4. The method according to claim 2, applied to a head-up imaging device, using at least one other colour to display in this colour information supplied by an onboard computer.

5. The method according to claim 1, wherein said set of pixels encompasses all the pixels of the display, to display an image that is spatially monochrome over the entire display.

6. The method according to claim 1, wherein said set of pixels comprises a portion of the pixels of the display, to display an image that is spatially monochrome in a corresponding area of the display, the other pixels of the display being able to be controlled to display information in the entire colour palette of the display.

7. The method according to claim 6, in which said other pixels are used to display a colour video image in an area of the display.

8. An imaging appliance comprising an imaging system comprising a liquid crystal display of the colour sequential type and a light box with at least two colours, in which said imaging system receives sequences of images to be displayed, generated according to an image construction method according to claim 1, in order to display spatially monochrome images.

9. An imaging appliance according to claim 8, for head-up imaging.

10. An imaging appliance according to claim 8, for direct viewing.
